(19) United States
(12) Patent Application Publication
(10) Pub. No.: US 2026/0359341 A1
(43) Pub. Date: Nov. 12, 2026

(54) GUARDRAIL SYSTEM AND PROGRAM

(71) Applicants: SoftBank Corp., Tokyo (JP); SB Intuitions Corp., Tokyo (JP)

(72) Inventors: Koki WATAOKA, Tokyo (JP); Pride KAVUMBA, Tokyo (JP); Tomoya KUROSAWA, Tokyo (JP); Masaya OHAGI, Tokyo (JP)

(21) Appl. No.: 19/667,460

(22) Filed: May 4, 2026

(30) Foreign Application Priority Data
May 7, 2025 (JP) 2025-077431
May 7, 2025 (JP) 2025-077432

(51) Int. Cl. G06F 16/353; G06F 21/62

(52) U.S. Cl. CPC G06F 16/353; G06F 21/6245

(57) ABSTRACT

It is possible to more safely carry out text generation using a generative model. A guardrail system includes a processor that executes: an acquisition process of acquiring text the input of which has been received by a user interface and which is to be input into a generative model, or text which has been generated by the generative model; a determination process of determining whether the acquired text satisfies a predetermined handling start condition; a classification process of classifying the text as any of a plurality of categories according to a predetermined classification criterion in a case where it has been determined in the determination process that the text satisfies the predetermined handling start condition; and a handling process of carrying out handling in accordance with a category as which the text has been classified in the classification process.

This Nonprovisional application claims priority under 35 U.S.C. §119 on Patent Application No. 2025-077431 filed in Japan on May 7, 2025 and Patent Application No. 2025-077432 filed in Japan on May 7, 2025, the entire contents of which are hereby incorporated by reference.

### TECHNICAL FIELD

The present disclosure relates to a guardrail system and a program.

### BACKGROUND ART

Non-Patent Literature 1 discloses the status of the effort in guardrail systems for ensuring the safety of large language models (LLMs) and AI.

### CITATION LIST

### Non-patent Literature

### Non-patent Literature 1

"LLM ni okeru ga-doreiru ni tsuite [Regarding Guardrails in LLM]". Website of Zenn. [online], Mar. 24, 2024 [retrieved on Apr. 1, 2024], Internet: <URL:https://zenn.dev/ayumuakagi/articles/llm_guardrails>

### SUMMARY OF INVENTION

### Solution to Problem

A guardrail system according to one aspect of Disclosure 1 includes: an acquisition section that acquires text the input of which has been received by a user interface and which is to be input into a generative model, or text which has been generated by the generative model; a determination section that determines whether the acquired text satisfies a predetermined handling start condition; a classification section that classifies the text as any of a plurality of categories according to a predetermined classification criterion in a case where the determination section has determined that the text satisfies the predetermined handling start condition; and a handling section that carries out handling in accordance with a category as which the text has been classified by the classification section.

A recording medium according to another aspect of Disclosure 1 is a non-transitory recording medium storing a program that causes a processor to execute: an acquisition process of acquiring text the input of which has been received by a user interface and which is to be input into a generative model, or text which has been generated by the generative model; a determination process of determining whether the acquired text satisfies a predetermined handling start condition; a classification process of classifying the text as any of a plurality of categories according to a predetermined classification criterion in a case where it has been determined in the determination process that the text satisfies the predetermined handling start condition; and a handling process of carrying out handling in accordance with a category as which the text has been classified in the classification process.

A guardrail system according to one aspect of Disclosure 2 includes: an acquisition section that sequentially acquires text the input of which has been received by a user interface and which is to be input into a generative model, or text which has been output by the generative model; a determination section that determines, every time a predetermined determination condition is established, whether the acquired text satisfies a predetermined handling start condition; and a handling section that carries out predetermined handling in a case where the determination section has determined that the text satisfies the predetermined handling start condition.

A recording medium according to another aspect of Disclosure 2 is a non-transitory recording medium storing a program that causes a processor to execute: an acquisition process of sequentially acquiring text the input of which has been received by a user interface and which is to be input into a generative model, or text which has been output by the generative model; a determination process of determining, every time a predetermined determination condition is established, whether the acquired text satisfies a predetermined handling start condition; and a handling process of carrying out predetermined handling in a case where it has been determined in the determination process that the text satisfies the predetermined handling start condition.

### BRIEF DESCRIPTION OF DRAWINGS

FIG. 1 is a block diagram showing an example of a schematic configuration of an information generation system including a guardrail system according to an embodiment of the present disclosure.

FIG. 2 is a diagram showing an example of a screen displayed by a user interface included in the information generation system according to the embodiment.

FIG. 3 is a block diagram showing an example of a functional configuration of the guardrail system according to the embodiment.

FIG. 4 is a table showing an example of a relationship between categories into which text is classified by the guardrail system according to the embodiment and handling to be carried out.

FIG. 5 is a table showing another example of the relationship between categories into which text is classified by the guardrail system according to the embodiment and handling to be carried out.

FIG. 6 is a sequence diagram showing an example of an operation of the guardrail system according to the embodiment.

FIG. 7 is a diagram showing an example of a screen displayed by the user interface according to the embodiment.

FIG. 8 is a diagram showing another example of the screen displayed by the user interface according to the embodiment.

FIG. 9 is a sequence diagram showing another example of the operation of the guardrail system according to the embodiment.

### DESCRIPTION OF EMBODIMENTS

### Background, Problems, Solutions, and Solution principles

The background of the present disclosure, problems of prior art, solutions to the problems, and solution principles achieved by the solutions will be described prior to the description of each embodiment of the present disclosure.

### BACKGROUND

In recent years, guardrail systems have become capable of detecting various types of harmful content.

### Problem 1

However, conventional guardrail systems can carry out only monotonous handling (for example, display of a warning) regardless of the type of harmful content.

### Solution 1

In order to solve the above problem, a guardrail system according to one aspect of Disclosure 1 includes: an acquisition section that acquires text the input of which has been received by a user interface and which is to be input into a generative model, or text which has been generated by the generative model; a determination section that determines whether the acquired text satisfies a predetermined handling start condition; a classification section that classifies the text as any of a plurality of categories according to a predetermined classification criterion in a case where the determination section has determined that the text satisfies the handling start condition; and a handling section that carries out handling in accordance with a category as which the text has been classified by the classification section.

### Solution Principle 1

The guardrail system classifies text satisfying the handling start condition (for example, text including harmful content or specialized content) into various categories and carries out handling in accordance with each of the categories. Thus, according to the guardrail system, for example, handling such as a warning and/or a request for re-input can be carried out with respect to relatively less harmful content, and safer handling such as operation stop and/or regeneration can be carried out with respect to relatively more harmful content.

### Problem 2

Conventional guardrails monitor, after input by a user or output of a generative model has been finished, whether text includes harmful content. This causes a problem in that a long time is required before the text is displayed, or the harmful content is temporarily displayed.

### Solution 2

In order to solve the above problem, a guardrail system according to one aspect of Disclosure 2 includes: an acquisition section that sequentially acquires text the input of which has been received by a user interface and which is to be input into a generative model, or text which has been generated by the generative model; a determination section that determines, every time a predetermined determination condition is established, whether the acquired text satisfies a predetermined handling start condition; and a handling section that carries out predetermined handling in a case where the determination section has determined that the text satisfies the handling start condition.

### Solution Principle 2

In the guardrail system, the determination section repeatedly determines, every time the predetermined determination condition is established, whether the text which has been sequentially acquired by the acquisition section satisfies the predetermined handling start condition. That is, the guardrail system monitors the acquired text in real time. Thus, according to the guardrail system, in a case where the determination section has determined, during acquisition of the text, that the handling start condition is satisfied (for example, harmful content is included), handling (for example, display of a warning, temporary suspension of input/output of the text, and/or the like) can be carried out at the point of time of determination.

### EMBODIMENT

Next, one embodiment of the present disclosure will be described in detail with reference to the drawings.

### Configuration of Information Generation System 100

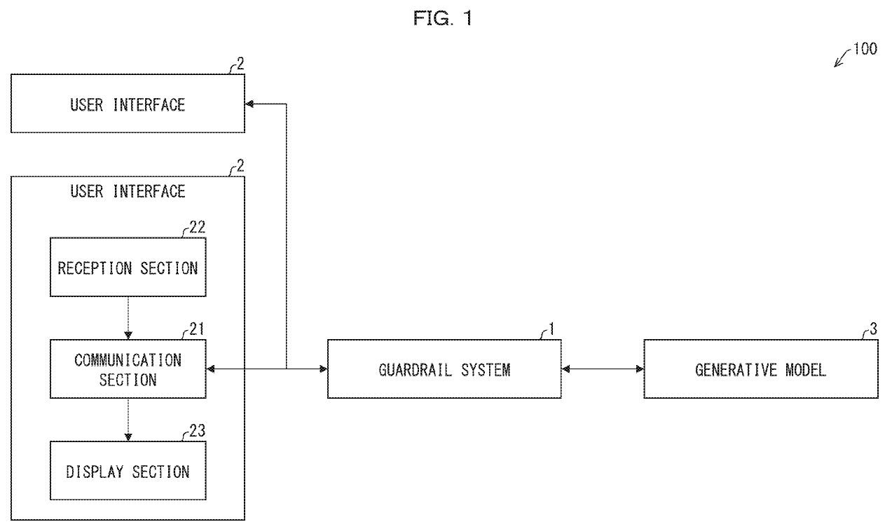

FIG. 1 is a block diagram showing an example of a schematic configuration of an information generation system 100 including a guardrail system according to the present embodiment. As shown in FIG. 1, the information generation system 100 is configured to include, in addition to a guardrail system 1, at least one user interface 2 (hereinafter, UI 2) and a generative model 3. The guardrail system 1, the UI 2, and the generative model 3 are connected to one another via a communication network.

### UI 2

The UI 2 receives input of text by a user. The UI 2 also presents output of the generative model 3 to the user. The UI 2 according to the present embodiment is constituted by, for example, a PC, a tablet terminal, a mobile phone, or the like. The UI 2 includes a communication section 21, a reception section 22, and a display section 23.

### Communication Section 21

The communication section 21 communicates with the guardrail system 1. The communication section 21 according to the present embodiment is constituted by a communication module.

### Reception Section 22

The reception section 22 is for receiving input of text by the user. The reception section 22 according to the present embodiment is constituted by a keyboard, a touch panel layered on the display section 23, or the like. The reception section 22 may be configured to sequentially convert a user's utterance into text.

### Display Section 23

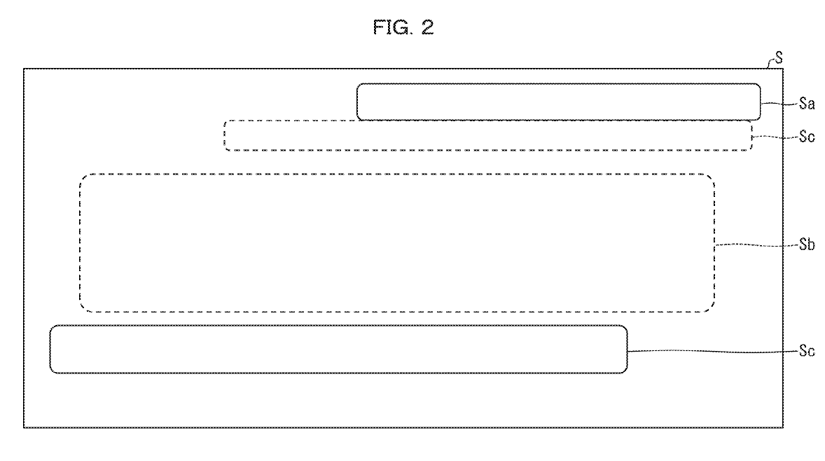

The display section 23 displays various types of text acquired from the guardrail system 1. The display section 23 according to the present embodiment displays, for example, an input/output screen S as shown in FIG. 2. The display section 23 displays, in an input field Sa of the input/output screen S, text the input of which has been received and which is to be input into the generative model, and displays, in an answer field Sb, text which has been generated by the generative model 3. The display section 23 also displays various types of information (for example, a warning, etc.) in other display field Sc of the input/output screen S. The input/output screen S may be displayed in a browser, or may be an input/output screen of a dedicated application installed in the UI 2. The input/output screen S may also be a chat-format screen that alternately displays the text the input of which has been received and the text which has been generated by the generative model 3. Hereinafter, the text the input of which has been received will be referred to as "input text," and the text which has been generated by the generative model 3 will be referred to as "generated text." In a case where the input text and the generated text are not distinguished from each other, the input text and the generated text will simply be referred to as "text."

### Generative Model 3

The generative model 3 is constructed to, upon input of input text, generate generated text having content in accordance with the input text. The generative model 3 according to the present embodiment is a large language model (LLM). The generative model 3 may be constructed to generate generated text after input of input text has been completed, or may be constructed to sequentially generate, from a stage during which the input text is being input, text having content in accordance with an already input portion.

### Guardrail System 1

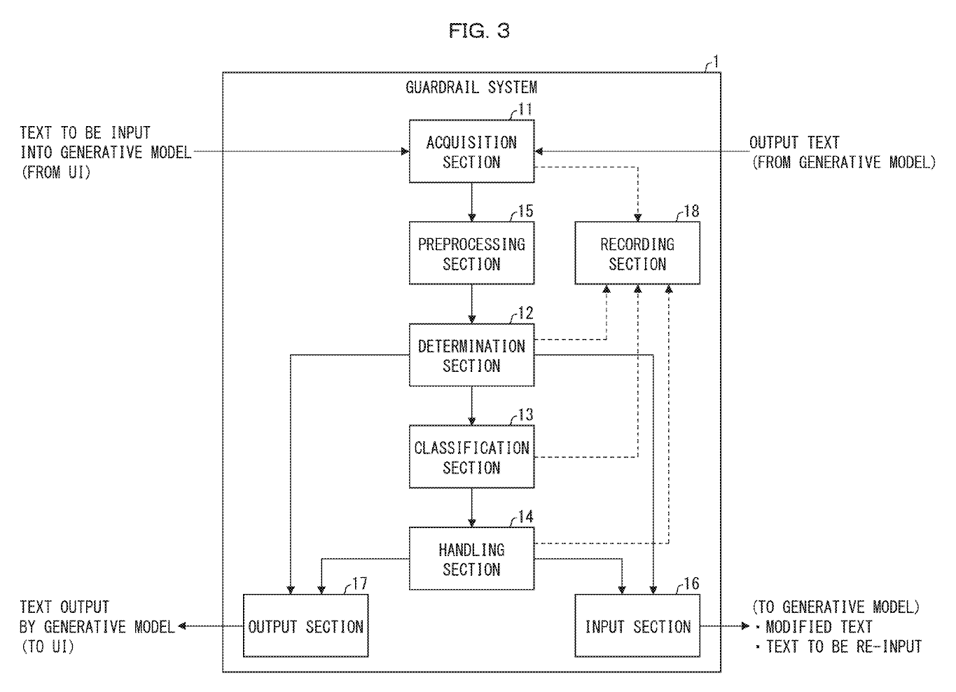

FIG. 3 is a block diagram showing an example of a functional configuration of the guardrail system 1 according to the present embodiment. The guardrail system 1 is interposed between the UI 2 and the generative model 3 and monitors input text and generated text. As shown in FIG. 3, the guardrail system 1 includes an acquisition section 11, a determination section 12, a classification section 13, and a handling section 14. The guardrail system 1 according to the present embodiment further includes a preprocessing section 15, an input section 16, an output section 17, and a recording section 18.

### Acquisition Section 11

The acquisition section 11 acquires text. The acquisition section 11 according to the present embodiment sequentially acquires text. That is, the acquisition section 11 acquires each character every time the UI 2 receives one character input or every time the generative model 3 outputs one character.

### Preprocessing Section 15

The preprocessing section 15 carries out normalization processing with respect to text. The normalization processing includes processing for unifying, into all full-width characters or all half-width characters, text in which full-width characters and half-width characters are mixed, processing for removing line breaks and unnecessary spaces, processing for normalizing special characters and symbols, and the like.

### Determination Section 12

The determination section 12 determines whether acquired text satisfies a predetermined handling start condition. The handling start condition includes the fact that text has harmful content. The determination section 12 according to the present embodiment uses a language model or a machine learning model to determine whether the acquired text satisfies the predetermined handling start condition. In a case where a language model is used, the determination section 12 utilizes natural language processing technology to analyze phrases included in text and the context of a sentence constituted by the text. In a case where a machine learning model (for example, a classifier) is used, the determination section 12 detects a harmful keyword by vocabulary-based filtering. The handling start condition may include the fact that text is a question or consultation regarding a specialized field, or an answer to the question or consultation. A rule-based determination may be combined with determination carried out by the determination section 12. Specifically, the determination section 12 may determine that the handling start condition is satisfied regardless of context in a case where the acquired text includes a highly harmful phrase or text. The determination section 12 may also determine, on the basis of a score output by a language model or a machine learning model, whether the handling start condition is satisfied. For example, the language model or the machine learning model may be trained to output a high score in a case where input text is highly harmful, and harmfulness may be determined on the basis of a predetermined threshold determined in advance.

The determination section 12 according to the present embodiment determines, every time a predetermined determination condition is established, whether the acquired text satisfies the predetermined handling start condition. The determination condition is that a predetermined time (for example, in a range of 0.1 sec to 1.0 sec) has elapsed since a previous determination as to whether the handling start condition is satisfied. This results in a plurality of times of repetition of determination during input of text by the user or during generation of text by the generative model 3, so that input by the user or output of the generative model 3 can be monitored in real time. The determination condition may be, for example, that text having a predetermined number of characters (for example, in a range of 10 characters to 100 characters) is input. The determination section 12 according to the present embodiment also determines, during a period from establishment of the predetermined determination condition until elapse of a predetermined waiting time, whether the handling start condition is satisfied.

The determination condition may be that reception of text input by the UI 2 or generation of text by the generative model 3 has been completed. That is, the determination section 12 may be configured to determine, after the acquisition section 11 has acquired all text, whether the handling start condition is satisfied. In a case where a dialogue is held between the user and the generative model 3, the determination section 12 may be configured to determine whether input text corresponding to the last utterance (input) by the user in the dialogue satisfies the handling start condition. Whether the dialogue has been held can be determined, for example, by referring to an internal log (details will be described later) stored in the recording section 18. For example, in a case where a dialogue is held in which, in response to a user's utterance of "Hello," the generative model 3 replies "Hello," and the user utters "How are you?", the determination section 12 determines whether the user's utterance of "How are you?" satisfies the handling start condition.

### Input Section 16

The input section 16 inputs input text into the generative model 3. As described above, the determination section 12 determines, during a period from establishment of the predetermined determination condition until elapse of a waiting time, whether the handling start condition is satisfied. Thus, after a predetermined waiting time has elapsed since establishment of the predetermined determination condition, the input section 16 according to the present embodiment inputs, into the generative model, the input text for which it has been determined whether the handling start condition is satisfied. The input section 16 may be configured to be capable of inputting, into the generative model 3, output text acquired by the acquisition section 11. In a case where the input text is configured to be directly transmitted from the UI 2 to the generative model 3, the guardrail system 1 need not include the input section 16.

### Output Section 17

The output section 17 outputs generated text to the UI 2. The output section 17 according to the present embodiment is constituted by a communication module. That is, the output section 17 according to the present embodiment transmits data of the generated text to the UI 2. After a predetermined waiting time has elapsed since the acquisition section 11 acquired the text, the output section 17 according to the present embodiment outputs, to the UI 2, output text for which it has been determined whether the handling start condition is satisfied. In a case where the generated text is configured to be directly transmitted from the generative model 3 to the UI 2, the guardrail system 1 need not include the output section 17.

### Classification Section 13

In a case where the determination section 12 has determined that text satisfies the handling start condition, the classification section 13 classifies the text as any of a plurality of categories according to a predetermined classification criterion. The categories include at least one of sexual expression, copyright infringement, violent expression, hate speech, false information, illegal act recommendation, and information leakage.

In a case where text includes pornographic content, sexual suggestions, or explicit words, the classification section 13 according to the present embodiment classifies the text as a category of sexual expression.

In a case where text includes at least part of another person's copyrighted work for which license has not been obtained, the classification section 13 classifies the text as a category of copyright infringement.

In a case where text includes violent depictions, threatening words, or content encouraging radical acts, the classification section 13 classifies the text as a category of violent expression.

In a case where text includes discriminatory remarks regarding race, religion, gender, sexual orientation, or the like, the classification section 13 classifies the text as a category of hate speech.

In a case where text includes incorrect information or content intentionally distorting facts, the classification section 13 classifies the text as a category of false information.

In a case where text includes content encouraging use of illegal drugs or commission of an illegal act, the classification section 13 classifies the text as a category of illegal act recommendation.

In a case where text includes personal information or confidential information, the classification section 13 classifies the text as a category of information leakage. The personal information includes a name, an address, a telephone number, an email address, a social security number, medical information, financial information, and the like of a third party. The confidential information includes corporate internal materials and strategic plans, unpublished patent information, state secrets, defense information, and the like.

In a case where the handling start condition includes the fact that the text is a question or consultation regarding a specialized field, or an answer to the question or consultation, the categories may include at least one of medical consultation, legal consultation, mental health consultation, and financial consultation. In this case, the classification section 13 classifies text as follows.

In a case where text includes a question regarding symptoms of a disease and a treatment method (for example, "Recently, my headaches have been severe; is there any good medicine?" or the like), the classification section 13 classifies the text as a category of medical consultation.

In a case where text includes a question regarding a specific legal issue and legal rights/obligations (for example, "I want to get divorced; what procedures should I carry out?" or the like), the classification section 13 classifies the text as a category of legal consultation.

In a case where text includes a question regarding a mental-health issue and self-diagnosis (for example, "Recently, I have been feeling very depressed; what should I do to feel better?" or the like), the classification section 13 classifies the text as a category of mental health consultation.

In a case where text includes a question regarding investment, loans, financial management, and/or the like, the classification section 13 classifies the text as a category of financial consultation.

The classification section 13 may set a severity level for each text subjected to classification into the categories. The severity level is an indicator indicating a level of harmfulness. The severity level may be represented by a level such as a low level, a medium level, or a high level, or may be represented by a numerical value. In a case where the handling section 14 (described later) is configured to carry out predetermined handling regardless of content of text, the guardrail system 1 need not include the classification section 13. The classification section 13 may classify content of text at a stage prior to the determination section 12. As one example, the determination section 12 may determine, on the basis of a classification result from the classification section 13, whether the predetermined handling start condition is satisfied.

### Handling Section 14

The handling section 14 carries out the predetermined handling in a case where the determination section 12 has determined that text satisfies the handling start condition. The handling section 14 according to the present embodiment carries out, as the predetermined handling, at least one of operation stop, a warning, a request for re-input, modification, and regeneration.

In a case where the predetermined handling is operation stop, the handling section 14 stops acquisition of a continuation of text from the UI 2 or the generative model 3. While acquisition of the continuation of the text is stopped, input of a continuation of input text into the generative model 3 by the input section 16 (display of the continuation of the input text by the UI 2) is stopped. While acquisition of a continuation of generated text is stopped, output of the continuation of the generated text to the UI 2 by the output section 17 (display of the continuation of the generated text by the UI 2) is also stopped.

In a case where the predetermined handling is a warning, the handling section 14 causes the UI 2 to display a warning message for at least one of the input text and the generated text. The warning message is a sentence indicating that text includes highly harmful content, a sentence indicating that text has been modified so as not to include highly harmful content, or a sentence indicating that text cannot be displayed because highly harmful content has been input or generated. The handling section 14 may cause the UI 2 to output the warning by voice.

In a case where the predetermined handling is a request for re-input, the handling section 14 causes the UI 2 to display a sentence requesting that text be re-input after content of the text is changed. The handling section 14 may cause the UI 2 to output the sentence by voice.

In a case where the predetermined handling is modification, the handling section 14 automatically modifies acquired text. The modification may be deletion or replacement of a harmful part, or may be modification of the entire acquired text.

In a case where the predetermined handling is regeneration, first, the handling section 14 deletes a harmful part from acquired input text. Then, by causing the input section 16 to input, into the generative model 3, the input text from which the harmful part has been deleted, the handling section 14 causes the generative model 3 to regenerate generated text. The handling section 14 may change a prompt to be input into the generative model 3 so that content of the changed prompt includes an instruction to consider harmfulness. Then, by causing the input section 16 to input the changed prompt, the handling section 14 may cause the generative model 3 to regenerate generated text.

In a case where the handling start condition includes the fact that the text is a question or consultation regarding a specialized field, or an answer to the question or consultation, the handling section 14 carries out, as the predetermined handling, at least one of a warning, consultation recommendation, general information presentation, and contact information presentation.

In a case where the predetermined handling is consultation recommendation, the handling section 14 causes the UI 2 to display a sentence encouraging consultation with an expert (doctor, attorney, psychological counselor, or the like). The handling section 14 may cause the UI 2 to output the sentence by voice.

In a case where the predetermined handling is general information presentation, the handling section 14 causes the UI 2 to display a sentence having very general content in a target field. This makes it possible to prevent content that may cause misunderstanding from being presented to the user. The handling section 14 may cause the UI 2 to output the sentence by voice.

In a case where the predetermined handling is contact information presentation, the handling section 14 causes the UI 2 to display information regarding an expert. This allows the user to directly consult, on the basis of output information, an expert closely related to content of the input text. Then, the user can obtain appropriate advice from an expert that the user has contacted.

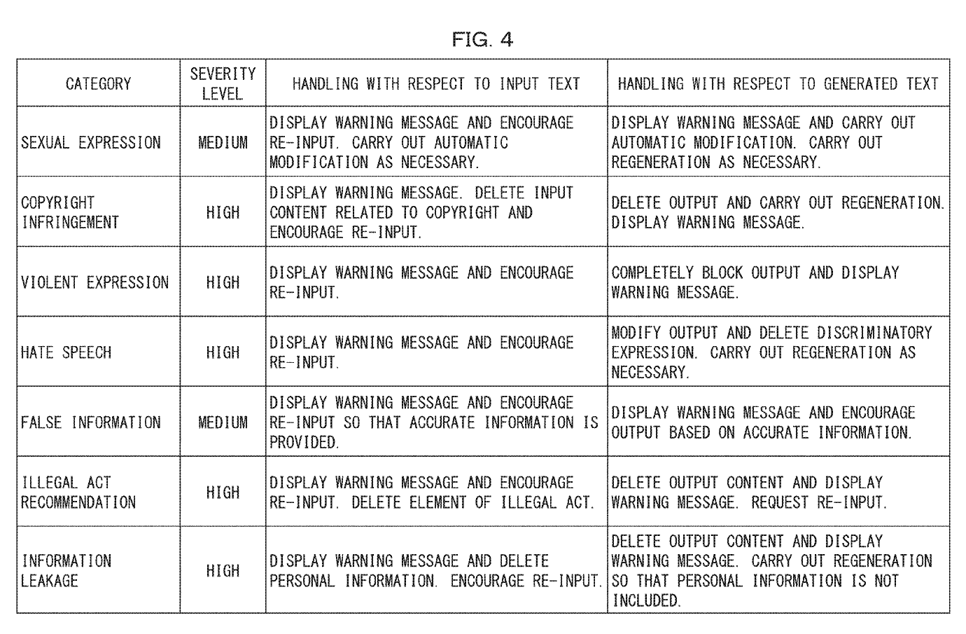

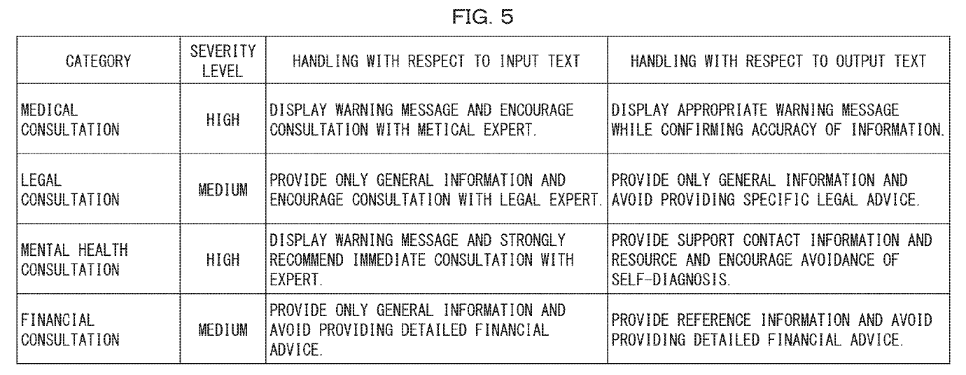

As described above, in the guardrail system 1 according to the present embodiment, the classification section 13 classifies text as any of a plurality of categories. Thus, the handling section 14 according to the present embodiment carries out handling in accordance with a category as which the text has been classified by the classification section 13. FIGS. 4 and 5 are tables showing examples of a relationship between categories into which text is classified by the guardrail system 1 and handling to be carried out.

As shown in FIG. 4, in a case where input text is classified into the category of sexual expression, the handling section 14 carries out, for example, a warning and a request for re-input. The handling section 14 also carries out modification as necessary. In contrast, in a case where generated text is classified as the category of sexual expression, the handling section 14 carries out a warning and modification. The handling section 14 also carries out regeneration as necessary.

In a case where the input text is classified as the category of copyright infringement, the handling section 14 carries out, for example, a warning, modification, and a request for re-input. In contrast, in a case where the generated text is classified as the category of copyright infringement, the handling section 14 carries out modification, regeneration, and a warning.

In a case where the input text is classified as the category of violent expression, the handling section 14 carries out, for example, a warning and/or a request for re-input. In contrast, in a case where the generated text is classified as the category of violent expression, the handling section 14 carries out operation stop and a warning.

In a case where the input text is classified as the category of hate speech, the handling section 14 carries out, for example, a warning and a request for re-input. In contrast, in a case where the generated text is classified as the category of hate speech, the handling section 14 carries out modification. The handling section 14 also carries out regeneration as necessary.

In a case where the input text is classified as the category of false information, the handling section 14 carries out, for example, a warning and a request for re-input. In contrast, in a case where the generated text is classified as the category of false information, the handling section 14 carries out a warning and regeneration.

In a case where the input text is classified as the category of illegal act recommendation, the handling section 14 carries out, for example, a warning, modification, and a request for re-input. In contrast, in a case where the generated text is classified as the category of illegal act recommendation, the handling section 14 carries out a warning, modification, and a request for re-input.

In a case where the input text is classified as the category of information leakage, the handling section 14 carries out, for example, a warning, modification, and a request for re-input. In contrast, in a case where the generated text is classified as the category of information leakage, the handling section 14 carries out a warning, modification, and regeneration.

As shown in FIG. 5, in a case where the input text is classified as medical consultation or mental health consultation, the handling section 14 carries out a warning and consultation recommendation. In contrast, in a case where the generated text is classified as the category of medical consultation or mental health consultation, the handling section 14 carries out a warning and contact information presentation.

In a case where the input text is classified as legal consultation, the handling section 14 carries out general information presentation and consultation recommendation. In contrast, in a case where the generated text is classified as legal consultation, the handling section 14 carries out general information presentation.

In a case where the input text is classified as financial consultation, the handling section 14 carries out general information presentation. In contrast, in a case where the generated text is classified as financial consultation, the handling section 14 carries out general information presentation.

In a case where a request for re-input is carried out or in a case where handling requiring at least a predetermined amount of time is carried out, operation stop may also be carried out together with said request or handling. This makes it possible to prevent display of highly harmful content on the UI before the user finishes re-input or while the handling section 14 is carrying out handling. In a case where the classification section 13 is configured to set a severity level for text, the handling section 14 may be configured to determine handling on the basis of the category and the severity level. In this case, the handling section 14 may be configured to determine whether the severity level is not less than a predetermined level, and to temporarily stop operation of the entire information generation system 100 in a case where the handling section 14 has determined that the severity level is not less than the predetermined level. In a case where the guardrail system 1 does not include the classification section 13, the handling section 14 may be configured to carry out a single type of handling (for example, only a warning).

### Recording Section 18

The recording section 18 records, as an internal log, text that has been acquired by the acquisition section 11, text that has been determined by the determination section 12 to satisfy the handling start condition, a classification result from the classification section 13, and content of handling by the handling section 14. The recorded internal log serves as data for being useful for improving the sections of the guardrail system 1.

### Software Implementation Example

Functions of the guardrail system 1 can be realized by a program for causing at least one computer to function as the system, the program causing the computer to function as each of control blocks of the system.

In this case, the system includes, as hardware for executing the program, a computer that has at least one control device (e.g., a processor) and at least one storage device (e.g., a memory). By executing the program by the control device and the storage device, each of the functions described in the above embodiment is realized.

The program may be recorded on one or a plurality of non-transitory computer-readable recording media. The recording medium may or need not be included in the system. In the latter case, the program may be supplied to the system via any wired or wireless transmission medium.

### Operation Example 1 of Information Generation System 100

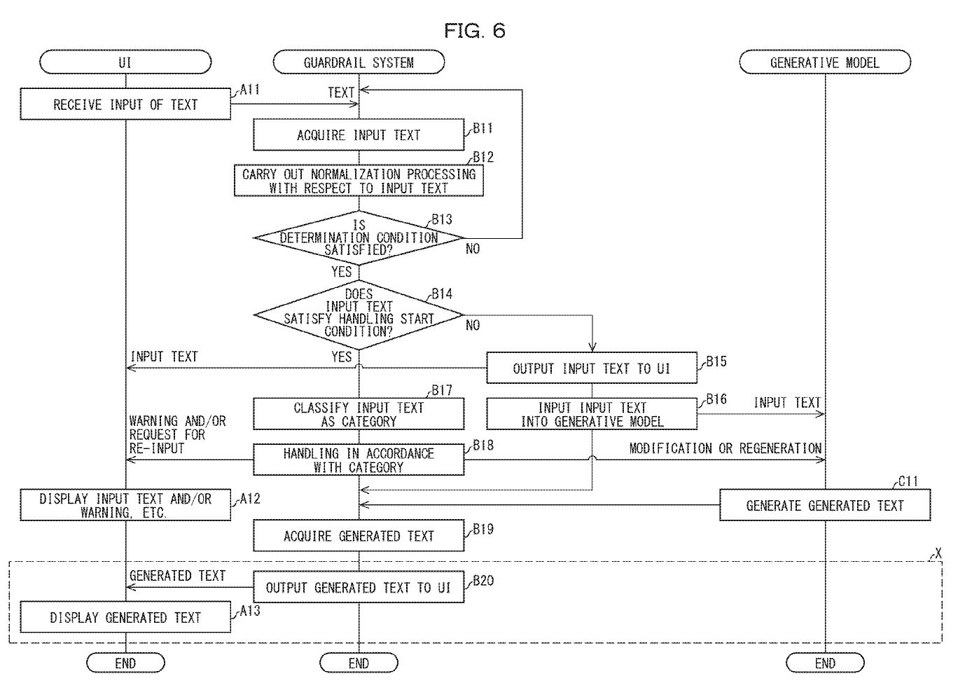

FIG. 6 is a sequence diagram showing an example of an operation of the guardrail system 1. The sections 11 to 17 of the guardrail system 1 operate, for example, in a flow as shown in FIG. 6.

First, the UI 2 receives input of input text by a user (A11). Then, the UI 2 transmits the received input text to the guardrail system 1.

Next, the acquisition section 11 acquires the input text (B11).

Subsequently, the preprocessing section 15 carries out normalization processing with respect to the input text acquired by the acquisition section 11 (B12).

In a case where monitoring is carried out in real time, next, the determination section 12 determines whether a determination condition is satisfied (B13). In a case where the determination section 12 has determined that the determination condition is not satisfied (NO in B13), the process returns to acquisition of the input text (B11). In a case where monitoring is not carried out in real time, B13 is skipped.

The determination section 12 which has determined that the determination condition is satisfied (YES in B13) determines whether the input text satisfies a predetermined handling start condition (B14).

In a case where the determination section 12 has determined that the input text does not satisfy the predetermined handling start condition (NO in B14), the output section 17 outputs the input text to the UI 2 (B15). Thus, the UI 2 displays the input text (A12). The input section 16 inputs the input text into the generative model 3 (B16). Thus, the generative model 3 generates generated text (C11).

Next, the generative model 3 into which the input text has been input generates the generated text corresponding to the input text (C11).

Subsequently, the acquisition section 11 acquires the generated text (B19).

Then, the output section 17 outputs the acquired generated text to the UI 2 (B20). Thus, the UI 2 displays the generated text (A13).

In a case where the determination section 12 determines in B14 that the input text satisfies the predetermined handling start condition (YES in B14), the classification section 13 classifies the input text as any of a plurality of categories according to a predetermined classification criterion (B17).

Next, the handling section 14 carries out handling (at least one of operation stop, a warning, a request for re-input, modification, and regeneration) in accordance with a category as which the input text has been classified by the classification section 13 (B18).

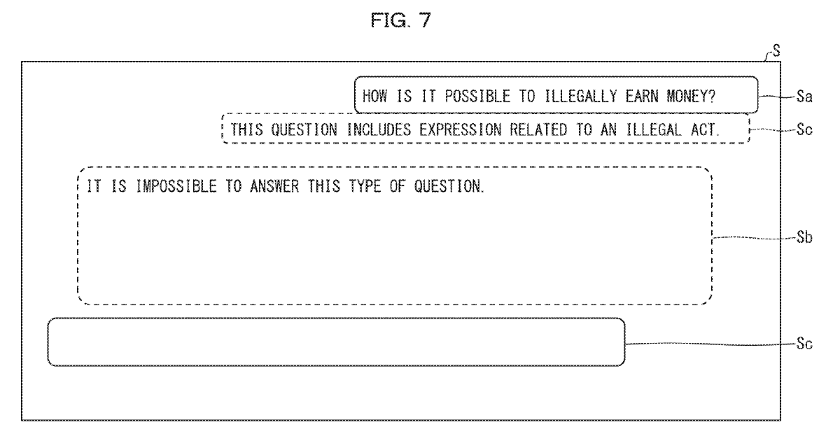

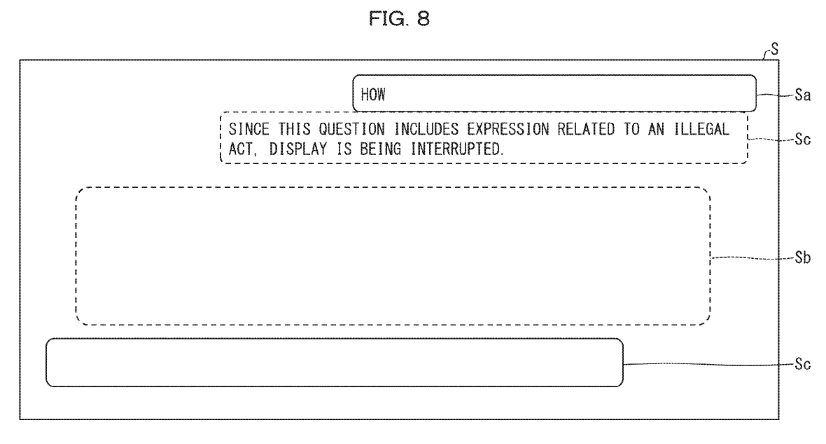

In a case where a warning and/or a request for re-input is/are carried out in B18, as shown in FIG. 7, the UI 2 displays, on the input/output screen S, at least one of a warning message and a sentence requesting that text be re-input (FIG. 7 illustrates the case of a warning message) (A12). In a case where the user re-inputs text, the process returns to reception of text input (A11). In contrast, in a case where modification or regeneration is carried out in B18, the generative model 3 generates generated text based on the modified input text or regenerates generated text (C11). In a case where operation stop is carried out in B18, as shown in FIG. 8, the UI 2 displays, on the input/output screen S, at least one of a warning message and a sentence requesting that text be re-input (FIG. 8 illustrates the case of a warning message), and input text that is being input (in a state in which input of highly harmful content has been received but has not been displayed) (A12).

After the generative model 3 generates the generated text, the acquisition section 11 acquires the generated text (B19).

Next, the output section 17 outputs the generated text to the UI 2. Thus, as shown in FIG. 7, the UI 2 displays the generated text (FIG. 7 illustrates the case of the generated text based on the modified input text or of regenerated generated text) (A13).

### Operation Example 2 of Information Generation System 100

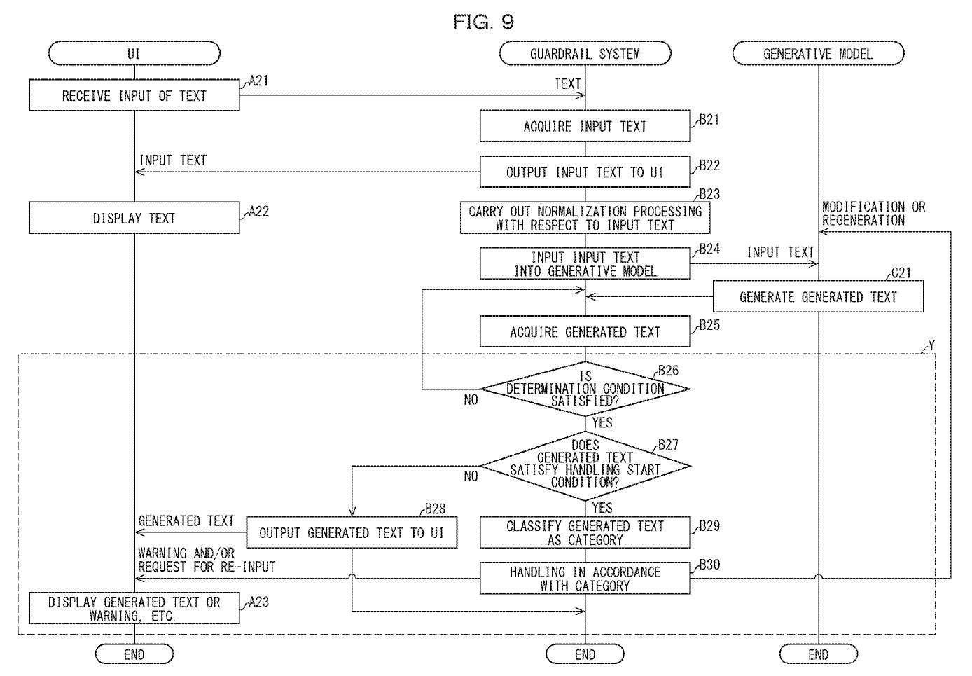

FIG. 9 is a sequence diagram showing another example of the operation of the information generation system 100. The guardrail system 1, the UI 2, and the generative model 3 that constitute the information generation system 100 can also operate, for example, as shown in FIG. 9.

First, the UI 2 receives input of input text by a user (A21). Then, the UI 2 transmits the received input text to the guardrail system 1.

Next, the acquisition section 11 acquires the input text (B21).

Subsequently, the output section 17 outputs the acquired input text to the UI 2 (B22). Thus, the UI 2 displays the input text (A22).

Next, the preprocessing section 15 carries out normalization processing with respect to the input text acquired by the acquisition section 11 (B23).

Subsequently, the input section 16 inputs the input text into the generative model 3 (B24). Thus, the generative model 3 generates generated text (C21).

Next, the acquisition section 11 acquires the generated text (B25).

In a case where monitoring is carried out in real time, next, the determination section 12 determines whether a determination condition is satisfied (B26). In a case where the determination section 12 has determined that the determination condition is not satisfied (NO in B26), the process returns to acquisition of the generated text (B25). In a case where monitoring is not carried out in real time, B26 is skipped.

The determination section 12 which has determined that the determination condition is satisfied (YES in B26) determines whether the generated text satisfies a predetermined handling start condition (B27).

In a case where the determination section 12 has determined that the generated text does not satisfy the predetermined handling start condition (NO in B27), the output section 17 outputs the generated text to the UI 2 (B28). Thus, the UI 2 displays the generated text (A23).

In a case where the determination section 12 determines in B27 that the generated text satisfies the predetermined handling start condition (YES in B27), the classification section 13 classifies the generated text as any of a plurality of categories according to a predetermined classification criterion (B29).

Next, the handling section 14 carries out handling (at least one of operation stop, a warning, a request for re-input, modification, and regeneration) in accordance with a category as which the generated text has been classified by the classification section 13 (B30).

In a case where a warning and/or a request for re-input is/are carried out in B30, the UI 2 displays, on the input/output screen S, at least one of a warning message and a sentence requesting that text be re-input (A23). In a case where the user re-inputs text, the process returns to reception of text input (A21). In contrast, in a case where modification or regeneration is carried out in B30, the generative model 3 generates generated text based on the modified input text or regenerates generated text (C21). In a case where operation stop is carried out in B30, the UI 2 displays, on the input/output screen S, a warning message and the generated text that is being displayed (in a state in which highly harmful content has been generated but has not displayed) (A23).

The sequence diagram shown in FIG. 6 indicates an operation of monitoring of both the input text and the generated text by replacing operations surrounded by broken lines X in FIG. 6 with operations surrounded by broken lines Y in FIG. 9. Note here that content and/or a level of handling by the handling section 14 may be changed in monitoring of the input text and the generated text. Specifically, a condition level(s) of the handling start condition and/or the determination condition in the determination section 12, and/or the type and/or number of classifications in the classification section 13 may be changed. As one example, the determination condition for the input text can be set more strictly than the determination condition for the generated text to stop subsequent processing with respect to text including harmfulness. As another example, speed of response to the UI 2 can be improved by making the number of classifications by the classification section 13 smaller for the generated text than for the input text. In addition, by carrying out monitoring under conditions suitable for each of the input text and the generated text, the handling section 14 can achieve a guardrail system that has both more suitable performance and redundancy.

In input and output of the information generation system 100 (guardrail system) according to the present embodiment, a target data format is not limited to a text format and may include video data such as images and moving images, program source codes, audio data, document and presentation file formats, design data such as CAD data, tabular-format and graph-format numerical data, and the like.

### Advantageous Effect 1 of Information Generation System 100 Guardrail System

The guardrail system 1 according to the present embodiment classifies, into various categories, harmful content or specialized content included in text, and carries out handling in accordance with each category. Thus, according to the guardrail system 1, for example, handling such as a warning and/or a request for re-input can be carried out with respect to relatively less harmful content, and safer handling such as operation stop and/or regeneration can be carried out with respect to relatively more harmful content. As a result, text generation using a generative model can be carried out more safely.

### Advantageous Effect 2 of Information Generation System 100 Guardrail System

In the guardrail system 1 according to the present embodiment, the determination section 12 repeatedly determines, every time the predetermined determination condition is established, whether the text which has been sequentially acquired by the acquisition section 11 satisfies the predetermined handling start condition. That is, the guardrail system 1 monitors the acquired text in real time. Thus, according to the guardrail system 1, in a case where the determination section 12 has determined, during acquisition of the text, that the handling start condition is satisfied (for example, harmful content is included), handling (for example, display of a warning, temporary suspension of input/output of the text, and/or the like) can be carried out at the point of time of determination. As a result, text generation using a generative model can be carried out more safely.

### Variation

The present disclosure is not limited to the embodiment described above, but can be altered in various ways within the scope of the claims. The present disclosure also encompasses, in its technical scope, any embodiment derived by combining, as appropriate, technical means disclosed in differing embodiments.

For example, the guardrail system 1 monitors both text acquired from the UI 2 (input by the user) and generated text. Note, however, that the guardrail system 1 may monitor only the text acquired from the UI 2, or may monitor only the generated text.

In the above embodiment, it has been explained that the functions of the guardrail system 1 can be realized by a program for causing a computer to function as each of the control blocks of the system. Some or all of functions of the control blocks can be realized by a logic circuit. For example, the present disclosure encompasses, in its scope, an integrated circuit in which a logic circuit functioning as each of the control blocks is formed. Alternatively, the functions of the control blocks can be realized by, for example, a quantum computer.

### Summary 1

A guardrail system according to Aspect 1-1 of the present disclosure includes: an acquisition section that acquires text the input of which has been received by a user interface and which is to be input into a generative model, or text which has been generated by the generative model; a determination section that determines whether the acquired text satisfies a predetermined handling start condition; a classification section that classifies the text as any of a plurality of categories according to a predetermined classification criterion in a case where the determination section has determined that the text satisfies the predetermined handling start condition; and a handling section that carries out handling in accordance with a category as which the text has been classified by the classification section.

In Aspect 1-2 of the present disclosure, a guardrail system may be configured such that, in Aspect 1-1 described above, the predetermined handling start condition includes the fact that the text has harmful content, and the categories include at least one of sexual expression, copyright infringement, violent expression, hate speech, false information, illegal act recommendation, and information leakage.

In Aspect 1-3 of the present disclosure, a guardrail system may be configured such that, in Aspect 1-1 or 1-2 described above, the predetermined handling start condition includes the fact that the text has content requesting an answer regarding a specialized field, and the categories include at least one of medical consultation, legal consultation, mental health consultation, and financial consultation.

In Aspect 1-4 of the present disclosure, a guardrail system may be configured such that, in Aspect 1-3 described above, the handling section not only carries out handling in accordance with the category but also outputs information regarding an expert to the user interface.

In Aspect 1-5 of the present disclosure, a guardrail system may be configured such that, in any of Aspects 1-1 to 1-4 described above, in a case where the text acquired by the acquisition section constitutes a plurality of sentences, the determination section determines whether the last sentence satisfies the predetermined handling start condition.

A recording medium according to Aspect 1-6 of the present disclosure is a non-transitory recording medium storing a program that causes a processor to execute: an acquisition process of acquiring text the input of which has been received by a user interface and which is to be input into a generative model, or text which has been generated by the generative model; a determination process of determining whether the acquired text satisfies a predetermined handling start condition; a classification process of classifying the text as any of a plurality of categories according to a predetermined classification criterion in a case where it has been determined in the determination process that the text satisfies the predetermined handling start condition; and a handling process of carrying out handling in accordance with a category as which the text has been classified in the classification process.

### Summary 2

A guardrail system according to Aspect 2-1 of the present disclosure includes: an acquisition section that sequentially acquires text the input of which has been received by a user interface and which is to be input into a generative model, or text which has been output by the generative model; a determination section that determines, every time a predetermined determination condition is established, whether the acquired text satisfies a predetermined handling start condition; and a handling section that carries out predetermined handling in a case where the determination section has determined that the text satisfies the predetermined handling start condition.

In Aspect 2-2 of the present disclosure, a guardrail system may be configured such that, in Aspect 2-1 described above, the determination condition is that a predetermined time has elapsed since a previous determination as to whether the predetermined handling start condition is satisfied.

In Aspect 2-3 of the present disclosure, a guardrail system may be configured such that, in Aspect 2-1 or 2-2 described above, the predetermined handling start condition includes the fact that the text has harmful content, and the handling section carries out, as the predetermined handling, at least one of operation stop, a warning, a request for re-input, modification, and regeneration.

In Aspect 2-4 of the present disclosure, a guardrail system may be configured such that, in any of Aspects 2-1 to 2-3 described above, the predetermined handling start condition includes the fact that the text is a question or consultation regarding a specialized field, or an answer to the question or consultation, and the handling section causes the user interface to display a warning.

In Aspect 2-5 of the present disclosure, a guardrail system may be configured, in any of Aspects 2-1 to 2-4 described above, to further include an input section that inputs, into the generative model, the text which is to be input into the generative model, the input section inputting the text into the generative model after a predetermined waiting time has elapsed since establishment of the predetermined determination condition, and the determination section determining, during a period before the predetermined waiting time elapses, whether the predetermined handling start condition is satisfied.

In Aspect 2-6 of the present disclosure, a guardrail system may be configured, in any of Aspects 2-1 to 2-5 described above, to further include an output section that outputs, to the user interface, the text which has been output by the generative model, the output section outputting the text to the user interface after a predetermined waiting time has elapsed since establishment of the predetermined determination condition, and the determination section determining, during a period before the predetermined waiting time elapses, whether the predetermined handling start condition is satisfied.

In Aspect 2-7 of the present disclosure, a guardrail system may be configured, in Aspect 2-3 described above, to further include an input section that inputs, into the generative model, the text which is to be input into the generative model, the handling section deleting a harmful part from the acquired text and causing the input section to input, into the generative model, the text from which the harmful part has been deleted, thereby causing the generative model to regenerate text.

In Aspect 2-8 of the present disclosure, a guardrail system may be configured, in Aspect 2-3 described above, to further include an input section that inputs, into the generative model, the text which is to be input into the generative model, the handling section changing a prompt to be input into the generative model so that content of the changed prompt includes an instruction to consider harmfulness, and causing the input section to input the changed prompt, thereby causing the generative model to regenerate text.

A recording medium according to Aspect 2-9 of the present disclosure is a non-transitory recording medium storing a program that causes a processor to execute: an acquisition process of sequentially acquiring text the input of which has been received by a user interface and which is to be input into a generative model, or text which has been output by the generative model; a determination process of determining, every time a predetermined determination condition is established, whether the acquired text satisfies a predetermined handling start condition; and a handling process of carrying out predetermined handling in a case where it has been determined in the determination process that the text satisfies the predetermined handling start condition.

### REFERENCE SIGNS LIST

100 Information generation system
1 Guardrail system
11 Acquisition section
12 Determination section
13 Classification section
14 Handling section
15 Preprocessing section
16 Input section
17 Output section
2 User interface
21 Communication section
22 Reception section
23 Display section
S Input/output screen
Sa Input field
Sb Answer field
Sc Other display field
3 Generative model
18 Recording section

1. A guardrail system comprising:
an acquisition section that acquires text the input of which has been received by a user interface and which is to be input into a generative model, or text which has been generated by the generative model;
a determination section that determines whether the acquired text satisfies a predetermined handling start condition;
a classification section that classifies the text as any of a plurality of categories according to a predetermined classification criterion in a case where the determination section has determined that the text satisfies the predetermined handling start condition; and
a handling section that carries out handling in accordance with a category as which the text has been classified by the classification section.

2. The guardrail system according to claim 1, wherein
the predetermined handling start condition includes the fact that the text has harmful content, and
the categories include at least one of sexual expression, copyright infringement, violent expression, hate speech, false information, illegal act recommendation, and information leakage.

3. The guardrail system according to claim 1, wherein
the predetermined handling start condition includes the fact that the text has content requesting an answer regarding a specialized field, and
the categories include at least one of medical consultation, legal consultation, mental health consultation, and financial consultation.

4. The guardrail system according to claim 3, wherein the handling section not only carries out handling in accordance with the category but also outputs information regarding an expert to the user interface.

5. The guardrail system according to claim 1, wherein, in a case where a dialogue is held between a user and the generative model, the determination section determines whether input text corresponding to the last utterance by the user in the dialogue satisfies the predetermined handling start condition.

6. A non-transitory recording medium storing a program that causes a processor to execute:
an acquisition process of acquiring text the input of which has been received by a user interface and which is to be input into a generative model, or text which has been generated by the generative model;
a determination process of determining whether the acquired text satisfies a predetermined handling start condition;
a classification process of classifying the text as any of a plurality of categories according to a predetermined classification criterion in a case where it has been determined in the determination process that the text satisfies the predetermined handling start condition; and
a handling process of carrying out handling in accordance with a category as which the text has been classified in the classification process.
